(19) United States
(12) Patent Application Publication
(10) Pub. No.: US 2013/0033868 A1
(43) Pub. Date: Feb. 7, 2013

(54) DISSIPATION EQUIPMENT FOR LED LIGHTING SYSTEMS

(71) Applicant: Massimo Gattari, Potenza Picena (IT)

(72) Inventor: Massimo Gattari, Potenza Picena (IT)

(21) Appl. No.: 13/562,793

(22) Filed: Jul. 31, 2012

(30) Foreign Application Priority Data
Aug. 2, 2011 (IT) FI2011A000161

(51) Int. Cl. F21V 29/00

(52) U.S. Cl. 362/249.02

(57) ABSTRACT

Built-in LED illumination device, comprising an optic assembly, adapted to assume different positions and inclinations with respect to the body of said lighting device, and a thermal dissipation module comprising in turn a fan, a conveyor associated to said fan and a heat sink integral with the optical assembly of said lighting device.

### FIELD OF THE INVENTION

The present invention relates to the field of lighting devices that use light sources of the point source type, in particular it relates to the field of lighting devices that use LED (Light Emitting Diodes) and devices for the disposal of heat generated during the operation of the said LED.

### STATE OF THE ART

The devices and the lighting equipment used today make an ever increasing use of LED (Light Emitting Diodes) by virtue of their ease of use and higher characteristics in terms of average life expectancy, flexibility of use and integration possibilities in small spaces, with respect to conventional light sources consisting of incandescent and fluorescent lamps.

Notwithstanding the technology concerning the LED light sources is characterised by constant development, such as to further improve the characteristics thereof and thus bring closer the final override of the LED with respect to all other light sources, one of the aspects that, up to date, is considered more problematic regards the thermal power dissipation of these devices and the need for effective disposal systems and thermal dissipation that follows thereof.

The current LED, in fact, emit under the shape of visible light radiation only 20 to 30% of the absorbed power and dissipate by conduction, convection and radiation the remaining 70 to 80%. This leads to the obvious need to equip the LED devices used for lighting, with adequate dissipation means that ensure the correct dissipation of heat generated in a manner to ensure the correct operation of the same LED device and of the surrounding circuitry.

In most cases, the most used method for this purpose involves the use of metal heat sinks, sized ad hoc, to be placed in contact with the LED device such as to dispose the thermal power thereof and to maintain the working temperature within such limits not to jeopardize the correct operation and not to lower the average life expectancy thereof. This solution, however, is limited by the thermal resistance of the heat sink under natural convection conditions. To obtain lower thermal resistances, and hence a more effective thermal dissipation, it becomes necessary to resort to the use of fans and conveyors which, however, are bulky and difficult to handle and cannot be used for all those lighting devices wherein the available sizes are often insufficient to house heat sink, fan and conveyor and for those devices wherein the optical assembly, comprising the LED and the related heat sinks, can assume different positions and inclinations with respect to the body of the lighting device.

Therefore, a first objective of the present invention, represents the introduction of a dissipation module for LED lighting systems adapted to be associated, in particular, to built-in LED lighting devices type; represents a further objective of the present invention, a built-in LED lighting device, comprising an optical assembly adapted to assume different positions and inclinations with respect to the body of said lighting device and a thermal dissipation module comprising a fan, a conveyor associated to said fan and a heat sink integral with the optical assembly of said lighting device.

### BRIEF DESCRIPTION OF THE FIGURES

FIG. 1 illustrates a first sectional view of the built-in LED lighting device according to the present invention and of the related dissipation module, wherein the optical assembly is not inclined with respect to the body of said lighting device.

FIG. 2 illustrates a second axonometric view of the built-in LED lighting device according to the present invention and the related dissipation module, wherein the optical assembly is inclined internally with respect to the body of said lighting device.

FIG. 3 illustrates a second sectional view of the built-in LED lighting device according to the present invention and the related dissipation module, wherein the optical assembly is inclined externally with respect to the body of said lighting device.

### SUMMARY OF THE INVENTION

The present invention relates to a built-in LED lighting device, comprising an optical assembly, adapted to assume different positions and inclinations with respect to the body of said lighting device, and a thermal dissipation module, comprising in turn a fan, a conveyor associated to said fan and a heat sink integral with the optical assembly of said lighting device.

### DETAILED DESCRIPTION OF THE INVENTION

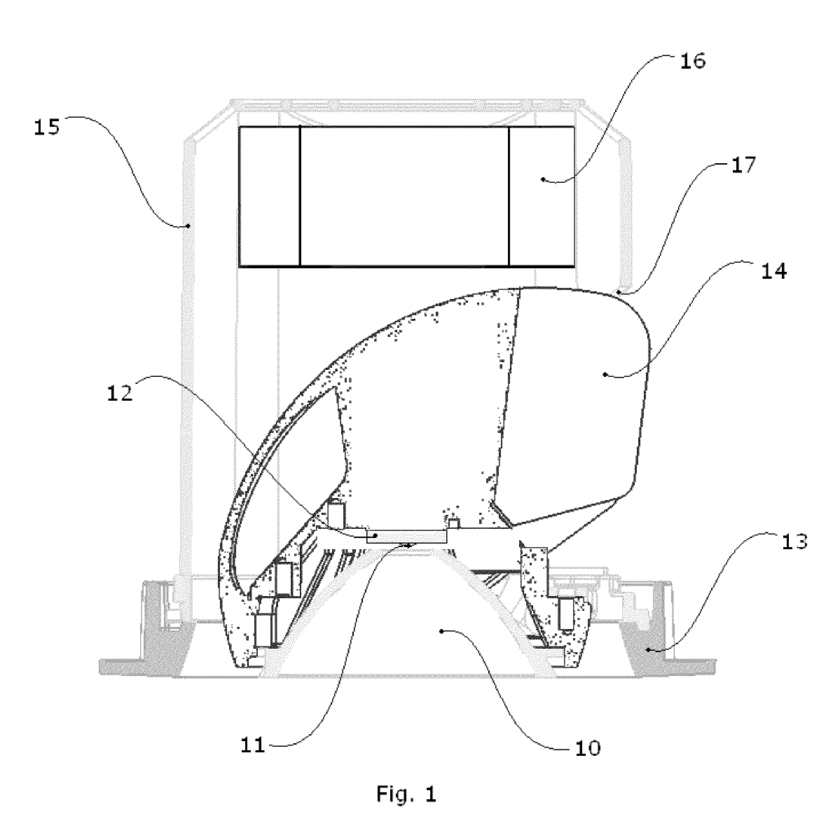

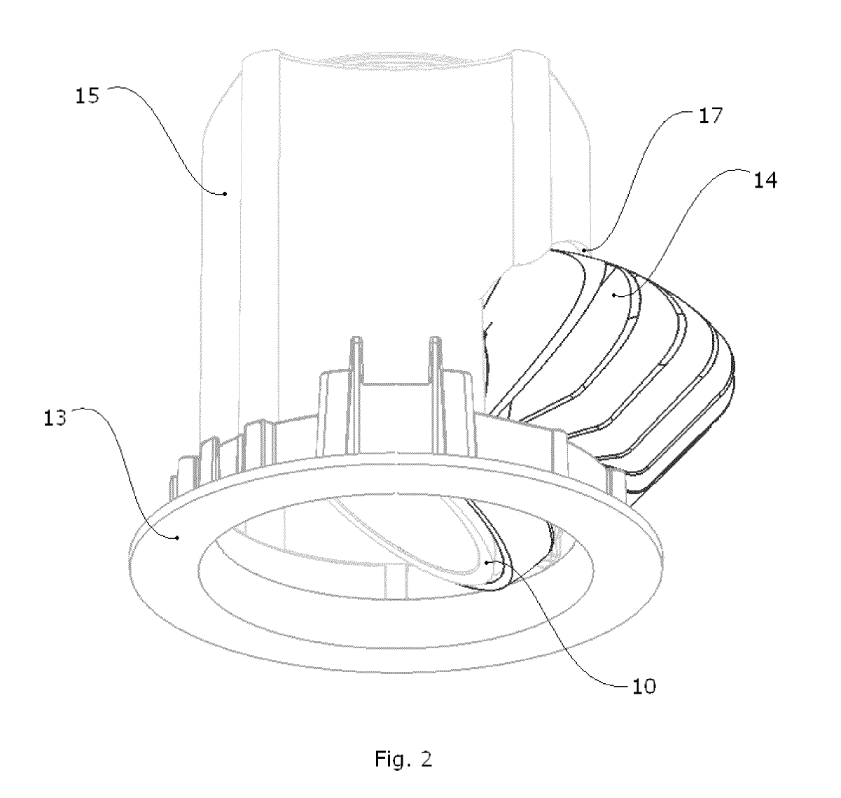

With reference to the attached FIGS. 1 and 2, the built-in LED lighting device according to the present invention comprises an optical assembly 10, in turn comprising at least one LED 11 associated to an appropriate support base 12 and appropriate means of power supply, and a frame 13, associated to said optical assembly 10 and equipped with suitable anchoring means to the wall, said optical assembly 10 being adapted to assume different positions and inclinations with respect to said frame 13, by extending outside therefrom or returning inside therein. The built-in LED lighting device according to the present invention further comprises a heat sink 14, preferably made of aluminium, associated to said support base 12 and in thermal contact therewith and with said at least one LED 11, a conveyor 15 associated to said heat sink 14 and comprising a fan 16, said conveyor 15 being equipped with an opening 17 adapted to allow said heat sink to pass in the cases wherein said optical assembly 10 is inclined with respect to said frame 13. In attached FIG. 2, said optical assembly 10 is inclined to enter partially within said frame 13.

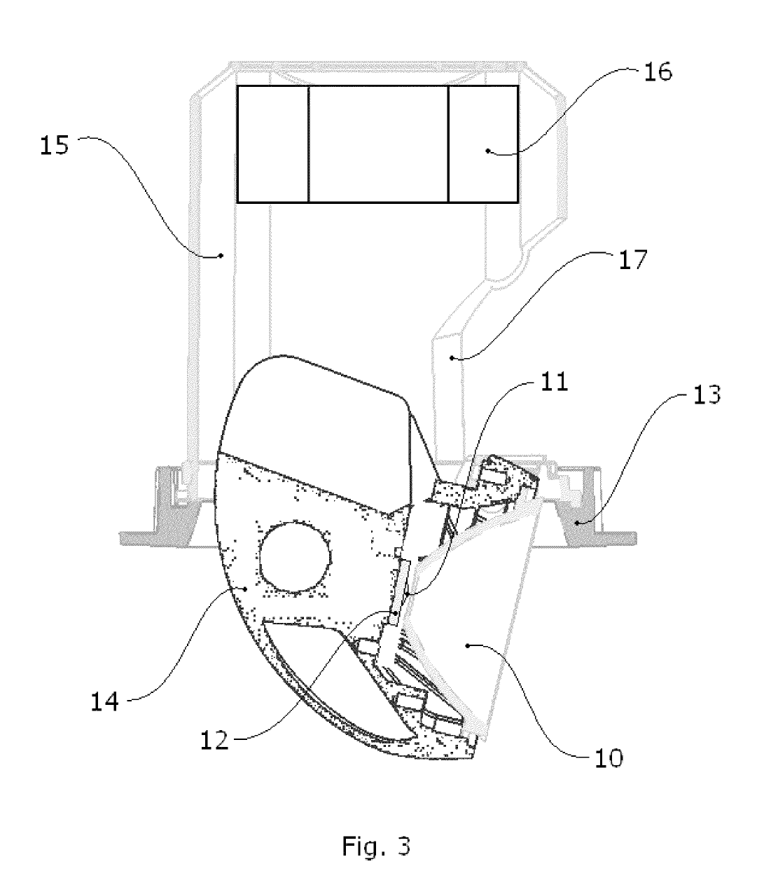

In a preferred embodiment of the built-in LED lighting device according to the present invention, said conveyor 15 is integral with said frame 13 and said heat sink 14 is made with an asymmetric shape and section, and such as to maximise the surface of the lugs and allow the reciprocal movement and positioning of said optical assembly 10 with respect to said frame 13, both inside—as illustrated in attached FIG. 2—and outside thereof, as illustrated in attached FIG. 3.

In a further preferred embodiment of the built-in LED lighting device according to the present invention, said conveyor 15 is provided with suitable fixing means to said frame 13 adapted to allow to said conveyor 15 to be inclined with respect to said frame 13, such as to ensure a further degree of freedom in case wherein the space available for the recess is of particularly small sizes.

In a further preferred embodiment of the present invention, said conveyor 15 is made of a cylindrical body, preferably of plastic material, comprising, on the bottom, suitable fixing means to said frame 13 and, at the other end, suitable fixing means for a fan.

The device according to the present invention can be made in various sizes and wattages, and finds advantageous use in all built-in applications, even in those wherein the space available inside the false ceiling is very small.

1. A built-in lighting device comprising an optical assembly, in turn comprising: at least one LED associated to a suitable small support base and to suitable power supply means; a frame, associated to said optical assembly and equipped with suitable anchoring means to the wall, said optical assembly being adapted to assume different orientations and inclinations with respect to said frame; a heat sink, associated to said small support base and in thermal contact therewith and with said at least one LED; a conveyor associated to said heat sink and comprising a fan, said conveyor being provided with an opening adapted to allow said heat sink to pass in the cases wherein said optical assembly is inclined with respect to said frame.

2. A device according to claim 1, wherein said conveyor comprises a cylindrical body, comprising, on the bottom, suitable fixing means to said frame and, at the other end, suitable fixing means for a fan.

3. A device according to claim 2, wherein said suitable fixing means to said frame are adapted to connect integrally said conveyor to said frame.

4. A device according to claim 2, wherein said suitable coupling means to said frame are adapted to connect said conveyor to said frame so as to allow a mutual, partial and reciprocal rotation in order to modify the inclination of said conveyor with respect to said frame.

5. (canceled)

6. (canceled)

7. (canceled)

8. A device according to claim 1, wherein said heat sink comprises an asymmetrical shape and section, and such to maximize the surface of the lugs, thus allowing the reciprocal movement and positioning of said optical assembly with respect to said frame.

9. A device according to claim 2, wherein said heat sink comprises an asymmetrical shape and section, and such to maximize the surface of the lugs, thus allowing the reciprocal movement and positioning of said optical assembly with respect to said frame.

10. A device according to claim 3, wherein said heat sink comprises an asymmetrical shape and section, and such to maximize the surface of the lugs, thus allowing the reciprocal movement and positioning of said optical assembly with respect to said frame.

11. A device according to claim 4, wherein said heat sink comprises an asymmetrical shape and section, and such to maximize the surface of the lugs, thus allowing the reciprocal movement and positioning of said optical assembly with respect to said frame.

12. A device according to claim 8, wherein said conveyor is made of plastic material.

13. A device according to claim 9, wherein said conveyor is made of plastic material.

14. A device according to claim 10, wherein said conveyor is made of plastic material.

15. A device according to claim 11, wherein said conveyor is made of plastic material.

16. A device according to claim 8, wherein said heat sink is made of aluminum.

17. A device according to claim 9, wherein said heat sink is made of aluminum.

18. A device according to claim 10, wherein said heat sink is made of aluminum.

19. A device according to claim 11, wherein said heat sink is made of aluminum.
